(19) United States
(12) Patent Application Publication
(10) Pub. No.: US 2005/0120155 A1
(43) Pub. Date: Jun. 2, 2005

(54) Multi-bus I2C system

(75) Inventor: Kuo-Sheng Chao, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO. LTD., Tu-Cheng City (TW)

(21) Appl. No.: 10/997,392

(22) Filed: Nov. 23, 2004

(30) Foreign Application Priority Data
Nov. 27, 2003 (TW) 92133308

(51) Int. Cl. G06F 13/14

(52) U.S. Cl. 710/305

(57) ABSTRACT

A multi-bus I²C (inter integrated circuit) system includes an 1²C controller (100), a CPU (200), an I²C bus (300), a decoder circuit (400), and eight I²C buses (510-580). The decoder circuit (400) of the multi-bus I²C system includes a binary decoder (410), a latch buffer (420), eight NOT gates (431-438), and eight NAND gates (441-448). The binary decoder (410) of the decoder circuit (400) is a 3-to-8 decoder. The multi-bus I²C system can include any number of I²C buses according to particular requirements. In such cases, the binary decoder (410) of the multi-bus I²C system has the required number of input ports and output ports. For example, the binary decoder (410) can be a 4-to-16 decoder.

### BACKGROUND OF THE INVENTION

1. Field of the Invention

The present invention relates to an inter integrated circuit (I²C) system, and particularly to a multi-bus I²C system that includes a plurality of I²C buses and a single I²C controller.

2. Description of Prior Art

Various electronic systems such as computers have basic common elements that enable the system to operate well. For example, a typical electronic system includes: a control unit such as a controller for controlling data transmission; a process unit such as a central processing unit (CPU) electrically connected to the control unit, the CPU being used for executing arithmetical and logical operations on data; a storage unit such as a random-access memory (RAM) electrically connected to the process unit; and an input/output unit such as a general purpose input/output (GPIO) port.

In order to enable an electronic system designer to effectively utilize the similarities of elements of a system, Philips Electronics has developed a simple bidirectional bus circuit system called an inter integrated circuit (I²C) system. The I²C system allows all I²C compatible devices connected to an I²C bus to communicate with each other directly. The I²C system solves many problems encountered by integrated circuit (IC) designers.

FIG. 3 is a schematic diagram of hardware infrastructure of an exemplary I²C system known in the art. The I²C system includes an I²C controller 10, a CPU 20, an I²C bus 30, and a plurality of devices. The devices may, for example, be one or more electrically erasable programmable read-only memories (EEPROMs) and analog to digital converters (ADCs). The I²C controller 10 includes an enable port for controlling the I²C controller 10 according to a voltage signal. The I²C controller 10 is active when the signal of the enable port is a low voltage signal, and the I²C controller 10 is inactive when the signal of the enable port is a high voltage signal. The CPU 20 is electrically connected to the I²C controller 10 via a data bus, an address bus and the enable port, and the I²C bus 30 is electrically connected to the I²C controller 10. The I²C bus 30 includes a serial data line (“SDA”) and a serial clock line (“SCL”). Each of the devices is electrically connected to the SDA and the SCL. The SDA is used for transmitting data and address information between the I²C controller 10 and the devices, and the SCL is used for controlling the SDA by a clock signal. The SDA is active when the clock signal on the SCL is a low voltage signal, and the SDA is inactive when the clock signal on the SCL is a high voltage signal.

The I²C controller of the I²C system only controls an I²C bus thereof. Each of the devices connected to the I²C bus is assigned a unique address ID, and the address IDs of the devices are represented by a byte (8 bits) in the I²C controller. 7 bits of the byte are used. Therefore, the number of devices connected to the I²C bus is limited to 128 (2⁷). As a result, more than one I²C system is required if the number of devices is more than 128. Consequently, an I²C system that includes a plurality of I²C buses and a single I²C controller is needed.

### SUMMARY OF THE INVENTION

A primary object of the present invention is to provide an I²C system that includes a plurality of I²C buses and a single I²C controller.

In order to fulfill the above-mentioned primary object, the present invention provides a multi-bus I²C system that includes a plurality of I²C buses and a single I²C controller. The multi-bus I²C system includes an I²C controller, a CPU, an I²C bus, a decoder circuit, a plurality of I²C buses, and a plurality of devices. The CPU is electrically connected to the I²C controller via a data bus and an address bus. The decoder circuit is electrically connected to the I²C controller via the I²C bus, and is electrically connected to the CPU. The plurality of I²C buses are electrically connected to the decoder circuit. The plurality of devices are electrically connected to the I²C buses.

The decoder circuit of the multi-bus I²C system includes a binary decoder, a latch buffer, a plurality of NOT gates, and a plurality of NOT AND (NAND) gates. The latch buffer is electrically connected to the binary decoder. The NOT gates are connected to the SCL of the I²C bus. The NAND gates are connected to the latch buffer and the NOT gates respectively. The binary decoder can be a 3-to-8 decoder.

The multi-bus I²C system can include any number of I²C buses according to particular requirements. In such cases, the binary decoder of the multi-bus I²C system has the required number of input ports and output ports. For example, the binary decoder can be a 4-to-16 decoder.

Other objects, advantages and novel features of the present invention will become more apparent from the following detailed description when taken in conjunction with the accompanying drawings.

### BRIEF DESCRIPTION OF THE DRAWINGS

FIG. 1 is a simplified block diagram of hardware infrastructure of an exemplary embodiment of the multi-bus I²C system according to the present invention.

FIG. 2 is a simplified block diagram of hardware infrastructure of a decoder circuit of the multi-bus I²C system of FIG. 1.

FIG. 3 is a block diagram of hardware infrastructure of an exemplary I²C system of the prior art.

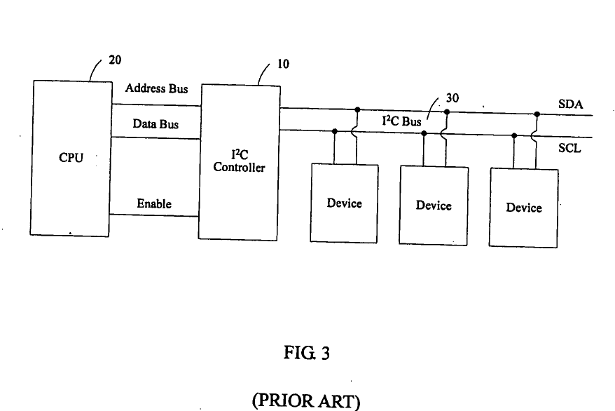

### DETAILED DESCRIPTION OF THE INVENTION

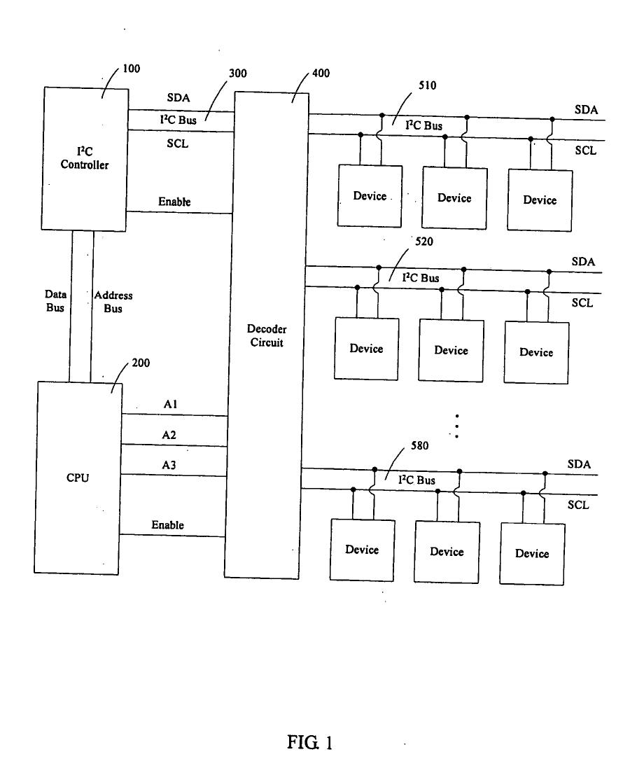

FIG. 1 is a block diagram of hardware infrastructure of the exemplary embodiment of the multi-bus I²C system of the present invention. In the exemplary embodiment, the multi-bus I²C system includes an I²C controller 100, a CPU 200, an I²C bus 300, a decoder circuit 400, eight I²C buses 510, 520, 530, 540, 550, 560, 570, 580, and a plurality of devices. The devices can be any of various kinds used in a particular application, and may for example include one or more electrically erasable programmable read-only memories (EEPROMs) and analog to digital converters (ADCs). The I²C controller 100 has an enable port for controlling the I²C controller 100 according to a voltage signal. The I²C controller 100 is active when the signal of the enable port is a low voltage signal, and the I²C controller 100 is inactive when the signal of the enable port is a high voltage signal. The CPU 200 is electrically connected to the I²C controller 100 via a data bus and an address bus. The decoder circuit 400 is electrically connected to the I²C controller 100 via the I²C bus 300, and is electrically connected to the CPU 200. The I²C buses 510, 520, 530, 540, 550, 560, 570, 580 are electrically connected to the decoder circuit 400. The plurality of devices are electrically connected to the I²C buses 510, 520, 530, 540, 550, 560, 570, 580.

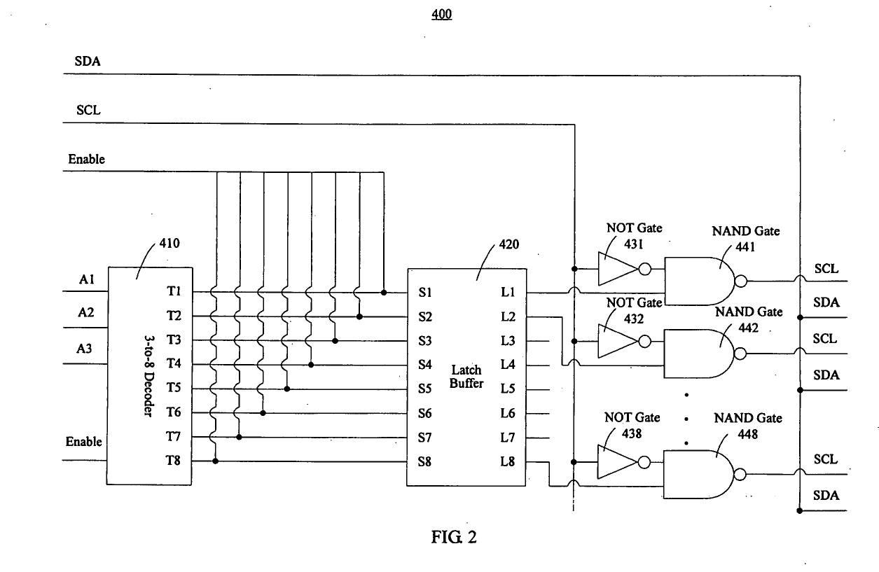

FIG. 2 is a block diagram of hardware infrastructure of the exemplary embodiment of the decoder circuit 400. The decoder circuit 400 includes a binary decoder 410, a latch buffer 420, eight NOT gates 431, 432, 433, 434, 435, 436, 437, 438, and eight NOT AND (NAND) gates 441, 442, 443, 444, 445, 446, 447, 448. In the exemplary embodiment, the binary decoder 410 is a 3-to-8 decoder. The 3-to-8 decoder 410 is used for selecting one of the I²C buses 510, 520, 530, 540, 550, 560, 570, 580 according to signals input from the CPU 200. The latch buffer 420 is electrically connected to the 3-to-8 decoder 410, for storing signals temporarily. The NOT gates 431, 432, 433, 434, 435, 436, 437, 438 are electrically connected to a serial clock line (“SCL”) of the I²C bus 300. Each of the NAND gates 441, 442, 443, 444, 445, 446, 447, 448 is respectively electrically connected to the eight NOT gates 431, 432, 433, 434, 435, 436, 437, 438, and is also electrically connected to the latch buffer 420.

The 3-to-8 decoder 410 has an enable port, three input ports A1, A2, A3, and eight output ports T1, T2, T3, T4, T5, T6, T7, T8. The enable port is electrically connected to the CPU 200 for controlling the 3-to-8 decoder 410 according to a voltage signal. The 3-to-8 decoder 410 is inactive when the signal of the enable port is a high voltage signal, and the 3-to-8 decoder 410 is active when the signal of the enable port is a low voltage signal. The output ports T1, T2, T3, T4, T5, T6, T7, T8 of the 3-to-8 decoder 410 are electrically connected to the enable port of the I²C controller 100. In the exemplary embodiment, the signal of the enable port of the I²C controller 100 is always a low voltage signal on the condition that one of the output ports Ti, T2, T3, T4, T5, T6, T7, T8 of the 3-to-8 decoder 410 is a low voltage signal. The latch buffer 420 has eight input ports S1, S2, S3, S4, S5, S6, S7, S8, and eight output ports L1, L2, L3, L4, L5, L6, L7, L8. The input ports S1, S2, S3, S4, S5, S6, S7, S8 of the latch buffer 420 are respectively electrically connected to the output ports T1, T2, T3, T4, T5, T6, T7, T8 of the 3-to-8 decoder 410 in one-to-one correspondence. The input ports of the NOT gates 431, 432, 433, 434, 435, 436, 437, 438 are electrically connected to the SCL of the I²C bus 300. First input ports of the NAND gates 441, 442, 443, 444, 445, 446, 447, 448 are respectively electrically connected to the output ports of the NOT gates 431, 432, 433, 434, 435, 436, 437, 438 in one-to-one correspondence. Second input ports of the NAND gates 441, 442, 443, 444, 445, 446, 447, 448 are respectively electrically connected to the output ports L1, L2, L3, L4, L5, L6, L7, L8 of the latch buffer 420 in one-to-one correspondence. The output ports of the NAND gates 441, 442, 443, 444, 445, 446, 447, 448 are respectively electrically connected to the SCL of the I²C buses 510, 520, 530, 540, 550, 560, 570, 580 in one-to-one correspondence. Serial data lines (“SDA”) of the I²C buses 510, 520, 530, 540, 550, 560, 570, 580 are electrically connected to the SDA of the I²C bus 300.

In the preferred embodiment, a low voltage signal is represented by a signal “0” and a high voltage signal is represented by a signal “1”. Therefore a combination of the voltage signals is represented by a binary sequence. For example, if all signals of the input ports A1, A2, A3 are low voltage signals, the combination of the voltage signals is represented as “000”. If all signals of the input ports A1, A2, A3 are high voltage signals, the combination of the voltage signals is represented as “111”.

When the signal on the SCL of the I²C bus 300 is “1”, the signal “1” is input to the input ports of the NOT gates 431, 432, 433, 434, 435, 436, 437, 438, and each of the NOT gates 431, 432, 433, 434, 435, 436, 437, 438 outputs a signal “0” according to the characteristic of the NOT gates 431, 432, 433, 434, 435, 436, 437, 438. The signal “0” is input to the first input ports of the NAND gates 441, 442, 443, 444, 445, 446, 447, 448, and each of the NAND gates 441, 442, 443, 444, 445, 446, 447, 448 outputs a signal “1” according to the characteristic of the NAND gates 441, 442, 443, 444, 445, 446, 447, 448. The signal “1” is input to the SCL of the I²C buses 510, 520, 530, 540, 550, 560, 570, 580, and the I²C buses 510, 520, 530, 540, 550, 560, 570, 580 remain in an inactive state.

On the other hand, when the signal on the SCL of the I²C bus 300 is “0,” the signal “0” is input to the input ports of the NOT gates 431, 432, 433, 434, 435, 436, 437, 438, and each of the NOT gates 431, 432, 433, 434, 435, 436, 437, 438 outputs a signal “1” according to the characteristic of the NOT gates 431, 432, 433, 434, 435, 436, 437, 438. The signal “1” is input to the first input ports of the NAND gates 441, 442, 443, 444, 445, 446,447, 448. According to the characteristic of the NAND gates 441, 442, 443, 444, 445, 446, 447, 448, the NAND gates 441, 442, 443, 444, 445, 446, 447, 448 output a signal “0” on the condition that a signal “1” is input to the second input ports thereof. When the signal “0” is input to the SCL of the I²C buses 510, 520, 530, 540, 550, 560, 570, 580, the I²C buses 510, 520, 530, 540, 550, 560, 570, 580 are in an active state.

When the signals input to the input ports A1, A2, A3 of the 3-to-8 decoder 410 are “000,” the output port T1 of the 3-to-8 decoder 410 outputs a signal “1,” and the other output ports T2, T3, T4, T5, T6, T7, T8 of the 3-to-8 decoder 410 output signals “0” simultaneously according to the characteristic of the 3-to-8 decoder 410. The signal “1” is input to the input port S1 of the latch buffer 420. As a result, the output port L1 of the latch buffer 420 outputs a signal “1” according to the characteristic of the latch buffer 420, and the I²C controller 100 is active. The signal “1” is input to the second input port of the NAND gate 441, and a signal “1” is input to the first input port of the NAND gate 441. According to the characteristic of the NAND gate 441, the NAND gate 441 outputs a signal “0.” The signal “0” is input to the SCL of the I²C bus 510. This results in the I²C bus 510 being in the active state, while the other I²C buses 520, 530, 540, 550, 560, 570, 580 still remain in the inactive state. The I²C bus 510 is thus selected.

When the signals input to the input ports A1, A2, A3 of the 3-to-8 decoder 410 are “001,” the output port T2 of the 3-to-8 decoder 410 outputs a signal “1” and the other output ports T1, T3, T4, T5, T6, T7, T8 of the 3-to-8 decoder 410 output signals “0” simultaneously according to the characteristic of the 3-to-8 decoder 410. The signal “1” is input to the input port S2 of the latch buffer 420. As a result, the output port L2 of the latch buffer 420 outputs a signal “1” according to the characteristic of the latch buffer 420, and the I²C controller 100 is active. The signal “1” is input to the second input port of the NAND gate 442, and a signal “1” is input to the first input port of the NAND gate 442. According to the characteristic of the NAND gate 442, the NAND gate 442 outputs a signal “0.” The signal “0” is input to the SCL of the I²C bus 520. This results in the I²C bus 520 being in the active state, while other I²C buses 510, 530, 540, 550, 560, 570, 580 still remain in the inactive state. The I²C bus 520 is thus selected.

When the signals input to the input ports A, A2, A3 of the 3-to-8 decoder 410 are “010,” the output portT3 of the 3-to-8 decoder 410 outputs a signal “1” and the other output ports T1, T2, T4, T5, T6, T7, T8 of the 3-to-8 decoder 410 output signals “0” simultaneously according to the characteristic of the 3-to-8 decoder 410. The signal “1” is input to the input port S3 of the latch buffer 420. As a result, the output port L3 of the latch buffer 420 outputs a signal “1” according to the characteristic of the latch buffer 420, and the I²C controller 100 is active. The signal “1” is input to the second input port of the NAND gate 443, and a signal “1” is input to the first input port of the NAND gate 443. According to the characteristic of the NAND gate 443, the NAND gate 443 outputs a signal “0.” The signal “0” is input to the SCL of the I²C bus 530. This results in the I²C bus 530 being in the active state, while the other I²C buses 510, 520, 540, 550, 560, 570, 580 still remain in the inactive state. The I²C bus 530 is thus selected.

When the signals input to the input ports A1, A2, A3 of the 3-to-8 decoder 410 are “011,” the output port T4 of the 3-to-8 decoder 410 outputs a signal “1” and the other output ports T1, T2, T3, T5, T6, T7, T8 of the 3-to-8 decoder 410 output signals “0” simultaneously according to the characteristic of the 3-to-8 decoder 410. The signal “1” is input to the input port S4 of the latch buffer 420. As a result, the output port L4 of the latch buffer 420 outputs a signal “1” according to the characteristic of the latch buffer 420, and the I²C controller 100 is active. The signal “1” is input to the second input port of the NAND gate 444, and a signal “1” is input to the first input port of the NAND gate 444. According to the characteristic of the NAND gate 444, the NAND gate 444 outputs a signal “0.” The signal “0” is input to the SCL of the I²C bus 540. This results in the I²C bus 540 being in the active state, while the other I²C buses 510, 520, 530, 550, 560, 570, 580 still remain in the inactive state. The I²C bus 540 is thus selected.

When the signals input to the input ports A1, A2, A3 of the 3-to-8 decoder 410 are “100,” the output port T5 of the 3-to-8 decoder 410 outputs a signal “1” and the other output ports T1, T2, T3, T4, T6, T7, T8 of the 3-to-8 decoder 410 output signals “0” simultaneously according to the characteristic of the 3-to-8 decoder 410. The signal “1” is input to the input port S5 of the latch buffer 420. As a result, the output port L5 of the latch buffer 420 outputs a signal “1” according to the characteristic of the latch buffer 420, and the I²C controller 100 is active. The signal “1” is input to the second input port of the NAND gate 445, and a signal “1” is input to the first input port of the NAND gate 445. According to the characteristic of the NAND gate 445, the NAND gate 445 outputs a signal “0.” The signal “0” is input to the SCL of the I²C bus 550. This results in the I²C bus 550 being in the active state, while the other I²C buses 510, 520, 530, 540, 560, 570, 580 still remain in the inactive state. The I²C bus 550 is thus selected.

When the signals input to the input ports A1, A2, A3 of the 3-to-8 decoder 410 are “101,” the output port T6 of the 3-to-8 decoder 410 outputs a signal “1” and the other output ports T1, T2, T3, T4, T5, T7, T8 of the 3-to-8 decoder 410 output signals “0” simultaneously according to the characteristic of the 3-to-8 decoder 410. The signal “1” is input to the input port S6 of the latch buffer 420. As a result, the output port L6 of the latch buffer 420 outputs a signal “1” according to the characteristic of the latch buffer 420, and the I²C controller 100 is active. The signal “1” is input to the second input port of the NAND gate 446, and a signal “1” is input to the first input port of the NAND gate 446. According to the characteristic of the NAND gate 446, the NAND gate 446 outputs a signal “0.” The signal “0” is input to the SCL of the I²C bus 560. This results in the I²C bus 560 being in the active state, while the other I²C buses 510, 520, 530, 540, 550, 570, 580 still remain in the inactive state. The I²C bus 560 is thus selected.

When the signals input to the input ports A1, A2, A3 of the 3-to-8 decoder 410 are “110,” the output port T7 of the 3-to-8 decoder 410 outputs a signal “1” and the other output ports T1, T2, T3, T4, T5, T6, T8 of the 3-to-8 decoder 410 output signals “0” simultaneously according to the characteristic of the 3-to-8 decoder 410. The signal “1” is input to the input port S7 of the latch buffer 420. As a result, the output port L7 of the latch buffer 420 outputs a signal “1” according to the characteristic of the latch buffer 420, and the I²C controller 100 is active. The signal “1” is input to the second input port of the NAND gate 447, and a signal “1” is input to the first input port of the NAND gate 447. According to the characteristic of the NAND gate 447, the NAND gate 447 outputs a signal “0.” The signal “0” is input to the SCL of the I²C bus 570. This results in the I²C bus 570 being in the active state, while the other I²C buses 510, 520, 530, 540, 550, 560, 580 still remain in the inactive state. The I²C bus 570 is thus selected.

When the signals input to the input ports A1, A2, A3 of the 3-to-8 decoder 410 are “111,” the output port T8 of the 3-to-8 decoder 410 outputs a signal “1” and the other output ports T1, T2, T3, T4, T5, T6, T7 of the 3-to-8 decoder 410 output signals “0” simultaneously according to the characteristic of the 3-to-8 decoder 410. The signal “1” is input to the input port S8 of the latch buffer 420. As a result, the output port L8 of the latch buffer 420 outputs a signal “1” according to the characteristic of the latch buffer 420, and the I²C controller 100 is active. The signal “1” is input to the second input port of the NAND gate 448, and a signal “1” is input to the first input port of the NAND gate 448. According to the characteristic of the NAND gate 448, the NAND gate 448 outputs a signal “0.” The signal “0” is input to the SCL of the I²C bus 580. This results in the I²C bus 580 being in the active state, while the other I²C buses 510, 520, 530, 540, 550, 560, 570 still remain in the inactive state. The I²C bus 580 is thus selected.

As described above, the binary decoder 410 of the exemplary embodiment of the multi-bus I²C system is a 3-to-8 decoder, and the maximum number of output ports is correspondingly limited to eight. As a result, the maximum number of I²C buses supported by the multi-bus I²C system is only eight. That is, the number of input ports of the binary decoder 410 is a factor that determines the maximum number of I²C buses. In other embodiments, the multi-bus I²C system can include more I²C buses according to particular requirements. In such cases, the binary decoder 410 of the multi-bus I²C system has more input ports and output ports. For example, the binary decoder 410 can be a 4-to-16 decoder.

Further, while an exemplary embodiment of the present invention has been described above, it should be understood that it has been presented by way of example only and not by way of limitation. Thus the breadth and scope of the present invention should not be limited by the above-described exemplary embodiment, but should be defined only in accordance with the following claims and their equivalents.

1. A multi-bus inter integrated circuit (I²C) system including:
an I²C controller;
a central processing unit (CPU) electrically connected to the I²C controller;
a decoder circuit electrically connected to the I²C controller and the CPU, the a decoder circuit including:
a binary decoder electrically connected to the CPU;
a latch buffer electrically connected to the binary decoder for storing signals temporarily;
a plurality of NOT gates connected to a serial clock line (SCL) of the I²C bus; and
a plurality of NOT AND (NAND) gates connected to the latch buffer and respective NOT gates; and
a plurality of I²C buses electrically connected to the decoder circuit.

2. The multi-bus I²C system of claim 1, further including an I²C bus for electrically connecting the I²C controller with the decoder circuit.

3. The multi-bus I²C system of claim 1, further including a plurality of devices electrically connected to the I²C buses.

4. The multi-bus I²C system of claim 1, wherein the binary decoder includes N input ports and 2^{N} output ports, N being a positive integer.

5. The multi-bus I²C system of claim 4, wherein the input ports of the binary decoder are electrically connected to the CPU.

6. The multi-bus I²C system of claim 1, wherein the latch buffer includes 2^{N} input ports and 2^{N} output ports, N being a positive integer.

7. The multi-bus I²C system of claim 6, wherein each input port of the latch buffer is electrically connected to a respective one of the output ports of the binary decoder in one-to-one correspondence.

8. The multi-bus I²C system of claim 2, wherein each input port of the NOT gate is electrically connected to the SCL of the I²C bus.

9. The multi-bus I²C system of claim 8, wherein each output port of the NOT gate is electrically connected to a first input port of a respective one of the NAND gates.

10. The multi-bus I²C system of claim 9, wherein each output port of the latch buffer is electrically connected to a second input port of a respective one of the NAND gates.

11. The multi-bus I²C system of claim 10, wherein each output port of the NAND gate is respectively electrically connected to the SCL of the I²C buses in one-to-one correspondence.

12. A multi-bus inter integrated circuit (I²C) system comprising:
an I²C controller providing an I²C bus having a data-transmitted line (SDA line) and a clock-signal line (SCL line) in order to control a plurality of devices;
a central processing unit (CPU) electrically connected to said I²C controller to control said I²C controller; and
means for multiplying said I²C bus electrically connected to said CPU and said I²C bus of said I²C controller so as to create a plurality of corresponding I²C buses to said I²C bus and each of said plurality of corresponding I²C buses having a corresponding SDA line and a corresponding SCL line to electrically connect with said plurality of devices; wherein
said corresponding SDA lines of said corresponding I²C buses are directly electrically connected with said SDA line of said I²C bus while said corresponding SCL lines of said corresponding I²C buses are electrically connected with said SCL line of said I²C bus via said means.

13. The multi-bus I²C system of claim 12, wherein said means comprises logic gates to connect with said SCL line of said I²C bus so as to control signals of said corresponding SCL lines of said plurality of corresponding I²C buses.

14. The multi-bus I²C system of claim 12, wherein said means comprises a binary decoder for multiplying said I²C bus.

15. A multi-bus inter integrated circuit (I²C) system comprising:
an I²C controller having an I²C bus;
a central processing unit (CPU) electrically connected to said I²C controller to communicate data and address infornation with said I²C controller; and
means for multiplying said I²C bus electrically connected to said CPU and said I²C controller so as to accept enabling signals from said CPU and perform multiplying of said I²C bus based on control signals from said CPU.

16. The multi-bus I²C system of claim 15, wherein said means comprises a binary decoder for multiplying said I²C bus.

17. The multi-bus I²C system of claim 15, wherein said I²C controller has an “enable” port to electrically connect with said means so as to effect each of multiplied I²C buses based on said enabling signals from said CPU.

18. The multi-bus I²C system of claim 15, wherein said means has more than one signal line to connect with said CPU for accepting more than one of unique control signals from said CPU to control exclusively a specially-defined multiplied I²C bus.
